(19) United States
(12) Patent Application Publication
(10) Pub. No.: US 2015/0317433 A1
(43) Pub. Date: Nov. 5, 2015

(54) USING DOUBLET INFORMATION IN GENOME MAPPING AND ASSEMBLY

(71) Applicant: Complete Genomics, Inc., Mountain View, CA (US)

(72) Inventors: Bahram Ghaffarzadeh Kermani, Los Altos, CA (US); Somayeh Bakhtiari, San Jose, CA (US)

(21) Appl. No.: 14/701,248

(22) Filed: Apr. 30, 2015

Related U.S. Application Data
(60) Provisional application No. 61/986,763, filed on Apr. 30, 2014.

(51) Int. Cl. G06F 19/22

(52) U.S. Cl. CPC G06F 19/22

(57) ABSTRACT

Systems, methods, and apparatuses are provided for determining a sequence of a heteropolymer molecule. For example, all or part of a chromosome or a protein can be determined using sequence data from a plurality of heteropolymer fragments corresponding to the heteropolymer molecule. As one example, a position in the sequence read of a DNA fragment can be identified where a single base call is not clear. A multiplet base call can then be used, where the multiplet base call includes two or more bases at the position, along with a score for each base. The scores can be carried through mapping and assembly procedures, where the scores can be used to determine a final base call for the position in a chromosome of a genome of an organism. Other examples can be used for other monomer units besides bases.

### CROSS-REFERENCES TO RELATED APPLICATIONS

The present application claims priority from and is a nonprovisional application of U.S. Provisional Application No. 61/986,763, entitled “Using Doublet Information In Genome Mapping And Assembly” filed Apr. 30, 2014, the entire contents of which are herein incorporated by reference for all purposes. This application is also related to commonly owned U.S. Non-Provisional application Ser. No. 14/571,022, entitled “Basecaller For DNA Sequencing Using Machine Learning” by Kermani et al., filed Dec. 15, 2014, the disclosure of which is incorporated by reference in its entirety.

### BACKGROUND

In genetics, the term sequencing may refer to methods for determining a primary structure or sequence of a biopolymer, including a nucleic acid (e.g., DNA, RNA etc.). More specifically, DNA sequencing is the process of determining an order of nucleotide bases (adenine, guanine, cytosine and thymine) in a given DNA fragment. Such sequencing methods commonly include calling a base at a position in a nucleic acid, where the called base is used to determine a sequence for the nucleic acid. The sequences for many nucleic acids can then be used to reconstruct (assemble) a genome of an organism.

When sequencing target nucleic acids, for example, the process typically includes extracting and fragmenting target nucleic acids from a sample. The fragmented nucleic acids are used to produce target nucleic acid templates that may include one or more adapters. The target nucleic acid templates may be subjected to amplification, such as bridge amplification to provide a cluster or rolling circle replication to provide a nucleic acid “nanoball,” e.g., a DNA nanoball (DNB). Sequencing applications are then performed on the single-stranded nucleic acids, e.g., by sequencing by synthesis or by ligation techniques, including combinatorial probe anchor ligation (cPAL).

An intensity value (e.g., a fluorescence signal) corresponding to a base that is incorporated into a nucleic acid at a particular position can indicate the base at that position. For example, four different types of fluorescence may be used, corresponding to the four types of bases to be identified. The nucleic acids are amenable to relatively inexpensive and efficient imaging techniques in which the nucleic acids are captured in four color images, one for each type of fluorescence used. The four images can then be processed through software to extract intensity information. Examples of incorporation are synthesis, ligation, and hybridization.

Typically, a single base having a highest intensity value is selected for the base call at a particular position. Or, a “no call” can be made when no base has a sufficiently high intensity value. Too many “no calls” in the sequence read of a DNA fragment can cause problems in reconstructing the genome of the organism.

### BRIEF SUMMARY

Embodiments of the present invention are directed to systems, methods, and apparatuses for determining a sequence of a heteropolymer molecule. For example, all or part of a chromosome or a protein can be determined using sequence data from a plurality of heteropolymer fragments corresponding to the heteropolymer molecule.

As one example, a position in the sequence read of a DNA fragment can be identified where a single base call is not clear. A multiplet base call can then be used, where the multiplet base call includes two or more bases at the position, along with a score for each base. The scores can be carried through mapping and assembly procedures, where the scores can be used to determine a final base call for the position in a chromosome of a genome of an organism. Other examples can be used for other monomer units besides bases.

Other embodiments are directed to systems and computer readable media associated with methods described herein.

### BRIEF DESCRIPTION OF THE DRAWINGS

FIG. 1 is a block diagram illustrating an example system for basecalling (e.g., as determined from digital images) of nucleic acids and using sequence reads to determine a sequence of the genome of an organism according to one embodiment.

FIG. 2 shows one example where a singleton call is made and another example where a doublet is called according to embodiments of the present invention.

FIG. 3 is a flowchart of a method 300 for determining at a least a portion of a sequence of a heteropolymer molecule of an organism according to embodiments of the present invention

FIG. 4 shows the number of combinations resulting from different numbers of doublets according to embodiments of the present invention.

FIG. 5 is a table showing errors (discordances) between a first basecaller/mapper and a second basecaller/mapper according to embodiments of the present invention.

FIG. 6 shows a plot of the percent of discordances at positions in a set of reads having 56 bases according to embodiments of the present invention.

FIG. 7 is a table showing the percentage of Kmers that have various numbers of doublets according to embodiments of the present invention.

FIG. 8 is a plot showing a percentage of concordant base calls for the base call with the highest score and the second highest score according to embodiments of the present invention. Call1 corresponds to the base call with the highest score.

FIG. 9 is a plot showing a percentage of concordant base calls when doublets are included according to embodiments of the present invention.

FIG. 10 shows a block diagram of an example computer system 10 usable with system and methods according to embodiments of the present invention.

### DEFINITIONS

The following definitions may be helpful in providing background for an understanding of embodiments of the invention.

A “sequence read” or “read” refers to data representing a sequence of monomer units (e.g., bases or amino acids) that comprise a nucleic acid molecule (e.g., DNA, cDNA, RNAs including mRNAs, rRNAs, siRNAs, miRNAs and the like), an amino acid molecule (e.g., a peptide or protein), or other molecules. The sequence read can be measured from a given molecule via a variety of techniques. A biological “heteropolymer” has various monomer units and corresponds to polynucleotides or oligonucleotides (e.g., DNA, RNA, etc.), proteins, peptides, proteins, and peptides, including both natural and artificial sequence types. A heteropolymer can be natural or artificial.

As used herein, a “fragment” refers to a heteropolymer molecule that is part of a larger heteropolymer molecule (e.g., a chromosome or protein). As examples, a fragment can be a nucleic acid fragment or an amino acid fragment. Fragments from a same larger molecule can be analyzed to determine a sequence of the larger molecule or of a region of the larger molecule. The fragments may not be from a same copy of the larger molecule (e.g., from different copies of a chromosome or protein), but are still referred to as being from a same larger molecule since the copies are of a same molecule. Fragments can be referred to as long or short, e.g., fragments longer than 10 Kb (e.g. between 50 Kb and 100 Kb) can be referred to as long, and fragments shorter than 1,000 bases can be referred to as short. A long fragment can be broken up into short fragments, upon which sequencing is performed.

A “mate pair” or “mated reads” or “paired-end” can refer to any two reads from a same molecule (also referred to as two arms of a same read) that are not fully overlapped (i.e., cover different parts of the molecule). Each of the two reads would be from different parts of the same molecule, e.g., from the two ends of the molecule. As another example, one read could be for one end of the molecule in the other read for a middle part of the molecule. As a genetic sequence can be ordered from beginning to end, a first read of a molecule can be identified as existing earlier in a genome than the second read of the molecule when the first read starts and/or ends before the start and/or end of the second read. More than two reads can be obtained for each molecule, where each read would be for a different part of the molecule. Usually there is a gap (mate gap) from about 100-10,000 bases of unread sequence between two reads. Examples of mate gaps include 500+/−200 bases and 1000+/−300 bases.

“Mapping” or “aligning” refers to a process which relates a read (or a pair of reads) to zero, one, or more locations in the reference to which the arm read is similar, e.g., by matching the instantiated arm read to one or more keys within an index corresponding to a location within a reference

As used herein, an “allele” corresponds to one or more nucleotides (which may occur as a substitution or an insertion) or a deletion of one or more nucleotides. A “locus” corresponds to a location in a genome. For example, a locus can be a single base or a sequential series of bases. The term “genomic position” can refer to a particular nucleotide position in a genome or a contiguous block of nucleotide positions. A “heterozygous locus” (also called a “het”) is a location in a reference genome or a specific genome of the organism being mapped, where the copies of a chromosome do not have a same allele (e.g. a single nucleotide or a collection of nucleotides). A “het” can be a single-nucleotide polymorphism (SNP) when the locus is one nucleotide that has different alleles. A “het” can also be a location where there is an insertion or a deletion (collectively referred to as an “indel”) of one or more nucleotides or one or more tandem repeats. A single nucleotide variation (SNV) corresponds to a genomic position having a nucleotide that differs from a reference genome for a particular person. An SNV can be homozygous for a person if there is only one nucleotide at the position, and heterozygous if there are two alleles at the position. A heterozygous SNV is a het. SNP and SNV are used interchangeably herein.

Sequencing refers to the determination of intensity values corresponding to positions of one or more nucleic acids. The “intensity values” can be any signal, e.g., electrical or electromagnetic radiation, such as visible light. There can be one intensity value per base, multiple intensity values per base, or fewer intensity values than there are bases. Also, an intensity value can be for a particular position, or an intensity value can be for multiple positions of a nucleic acid. Intensity values can be restricted to predetermined values (e.g., binary or integers in a decimal numeral system), or can have continuous values.

A “sequencing process” or “sequencing run” refers to the determination of intensity values corresponding to positions of one or more nucleic acids as a batch. For example, when the sequencing involves imaging biochemical reactions of nucleic acids on a substrate, the resulting intensity values are obtained during the same sequencing run. Intensity values of nucleic acids for a different substrate would appear in different sequencing runs. A nucleic acid of a first sequencing run would not be involved in a second sequencing run (e.g., not included in a same image).

A “machine-learning model” (also referred to as a model) refers to techniques that predict that output based on known results (training data). The known results can be an assumed sequence, which is assumed to be correct. As the model attempt to predict the results of the training data, the machine learning can also be referred to as supervised learning, or the supervision comes from the training data.

A “monomer call” corresponds to a determination of a monomer (potentially two or more for a multiplet) at a position in a heteropolymer molecule. As an example, a “base call” is a determination of a base at a position in a nucleic acid. When the nucleic acid is a fragment, the base call can be referred to as a preliminary base call, which is a type of a preliminary monomer call. A base call can be a no-call or one or more specified bases, e.g., a doublet call when a clear base call is not known. A base call can be made independently or as part of a combination of specified bases (e.g., A/T), which can be for a same genomic position (e.g., if respective scores are close to each other) or for multiple positions. When the nucleic acid is part of a larger nucleic acid molecule (e.g., a chromosome of a genome) that is reconstructed, the base call can be referred to as a final base call. The example descriptions for base calls are applicable to other monomers, collectively referred to as a “monomer call.”

A monomer can have a “score” that is a measure of a likelihood of a particular monomer (e.g., a base or amino acid) being at a position in a heteropolymer fragment (e.g., a DNA fragment, RNA fragment, or a protein fragment). A plurality of preliminary base calls can be made for a same position of a sequence read, with each preliminary base call having a corresponding score. A correct base call would generally have a higher score than an incorrect base call. A score at a position of a heteropolymer is determined based on intensity values for different monomers at the position, where a higher intensity value for a monomer corresponds to a higher score. A score can be provided for each of the monomer units (e.g., each base). Examples of a score can be a probability, possibility, or a rank. The probability scores for each of the bases would sum to a fixed number, i.e., one. The possibility scores are not required to sum to the fixed number. Each possibility score can be constrained to be between 0 and 1. The possibility scores could sum to 1, particularly if a model is trained well. An example model is a machine-learning model.

A “multiplet” corresponds to a preliminary base call of two or more bases. A doublet corresponds to two bases being called at a position of a sequence read. A triplet corresponds to three bases being called. A score for each of the bases can be used at mapping and/or assembly stages to determine a genomic sequence of the organism, e.g., a chromosome or entire genome. When the heteropolymers are something other than DNA fragments, the mapping and/or assembly stages can be used to determine a corresponding sequence of monomers, e.g., a protein sequence.

### DETAILED DESCRIPTION

Embodiments of the present invention are directed to systems, methods, and apparatuses for determining at least a portion of the genome of an organism, or other sequence of monomer units, e.g., amino acids of a protein. For example, positions in the sequence read of a DNA fragment can be identified where a single base call is not clear, or where a monomer call in a different heteropolymer is not clear. A multiplet base call can then be used. The multiplet base call includes two or more bases at the position, along with a score for each base. The scores can be carried through mapping and assembly procedures. A monomer call may not be clear at a particular position when one score is not greater than a specified amount than a next highest score.

### I. Basecalling

Various sequencing techniques can be used to obtain intensity values. For example, many nucleic acid molecules can be deposited on a substrate (slide). The molecules can be deposited in an ordered array (lattice) of nucleic acid molecules that can have any geometry, e.g., a rectangular (including square), checkerboard (lattice positions neighboring corners and not sides, such as black boxes on a checkerboard), or hexagonal lattice, or in a non-ordered fashion. Distinct locations on the substrate can correspond to different starting molecules. In other embodiments, the molecules can flow through channels within which sequencing is performed. During the sequencing process, intensity values from molecules on a given substrate can be obtained simultaneously for a given cycle, where each cycle corresponds to a different position on a molecule. For example, an image of a substrate can include different locations that emit light, where each position can emit signals of different wavelengths for each base. As mentioned above, the intensity values obtained from sequencing can be used to call a base at a position of each of the nucleic acid molecules.

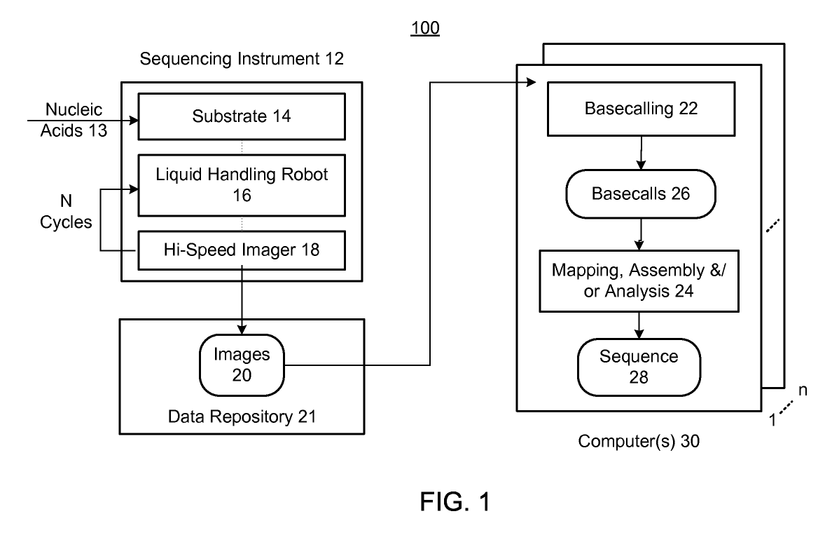

FIG. 1 is a block diagram illustrating an example system 100 for basecalling (e.g., as determined from digital images) of nucleic acids and using sequence reads to determine a sequence of the genome of an organism according to one embodiment. In this embodiment, system 100 may include a sequencing instrument 12 and a cluster of one or more computers 30. The computers 30 may be connected to the sequencing instrument 12 via a direct wired or wireless connection or via a high-speed local area network (not shown). The sequencing instrument 12 may include primary sub-systems such as a substrate 14 for holding nucleic acids 13, a liquid handling robot 16, and a high-speed imager 18. At least a portion of the computers 30 may execute instances of software components in parallel, including a basecalling component 22 (which may utilize a machine-learning model) and a mapping, assembly, and/or analysis component 24.

Computers 30 may include typical hardware components (not shown) including one or more processors, input devices (e.g., keyboard, pointing device, etc.), and output devices (e.g., a display device and the like). Computers 30 may include computer-readable/writable media, e.g., memory and storage devices (e.g., flash memory, a hard drive, an optical disk drive, a magnetic disk drive, and the like) containing computer instructions that implement the functionality disclosed when executed by the processors. Computers 30 may further include software and/or hardware for controlling the sequencing instrument 12 and computer writeable media for storing the base calls 26.

Sequencing can operate on input nucleic acids 13, which may be obtained by extracting larger molecules from a sample or target organism and fragmenting them. In various embodiments, nucleic acids 13 may be derived from a gene, a regulatory element, genomic DNA, cDNA, RNAs including mRNAs, rRNAs, siRNAs, miRNAs and the like and fragments thereof. Any suitable sequencing technique may be used to provide intensity values, e.g., as described in U.S. Pat. No. 8,518,640; US Patent Publication 2014/0051588 entitled “Sequencing Small Amounts of Complex Nucleic Acids” by Drmanac et al., filed Apr. 16, 2012, the disclosures of which are incorporated by reference in its entirety; Drmanac et al., Science 327:78-81, 2010; and Peters et al., Nature 487:190-195, 2012. In one embodiment, nucleic acids 13 are placed onto one or more substrates 14, and the substrates 14 are then inserted into the sequencing instrument 12. Substrate 14 may be either un-patterned or patterned. In the un-patterned embodiment, samples of nucleic acid may each be deposited in discrete locations on the substrate 14, but the locations need not be fixed. An example of a patterned substrate is described in US Patent Publication 2013/0323652, entitled “Method of Fabricating Patterned Functional Substrates” by Fernandez et al., filed Jun. 5, 2012, the disclosure of which is incorporated by reference in its entirety.

In one embodiment where fluorescence detection is used, high-speed imager 18 may form a four-color fluorescence microscope. In one implementation, each position on one of the nucleic acids can be imaged for each cycle. Substrate 14 can be divided up into fields, which may form lanes. Images can be taken of one field at a time, with all fields being imaged once for a cycle. High-speed imager 18 may store images 20 in a data repository 21.

Images 20 from data repository 21 are processed by basecalling component 22 for generation of base calls 26. Basecalling component 22 comprises program instructions that process the images 20 to identify the bases (e.g., nucleotides A, T, G or C) at each position in the nucleic acid 13. Different positions can correspond to different sequential sequencing/reaction cycles (hereinafter, “cycles”). During each cycle, a different position of a nucleic acid 13 is interrogated and at least one image of the nucleic acid 13 is captured. The basecalls 26 for each position in a nucleic acid 13 may be collated to form a sequence read. As described below, basecalling component 22 can include multiple stages of basecalling, as well as mapping and assembly, particularly when system 100 is used in a training mode. After final base calling is performed, Mapping, Assembly &/or Analysis component 24 may operate on the sequence reads and may produce a variety of outputs, including reads aligned to a reference genome (not shown) and consensus sequence assembly of overlapping reads, shown as sequence 28. Sequence 28 can be output and analyzed by software or a person to identify characteristics of the organism, e.g., whether the organism has a particular disease, is predisposed to a particular disease, has a particular genetic trait, etc.

U.S. Non-Provisional application Ser. No. 14/571,022 (entitled “Basecaller For DNA Sequencing Using Machine Learning” and filed Dec. 16, 2013) provides a description of a basecaller using machine learning, which can output a score for each base. The disclosure of U.S. Provisional application Ser. No. 14/571,022 is incorporated by reference in its entirety. Other basecallers can be used to produce scores that can be compared to each other, e.g., when the scores are calibrated or otherwise normalized. The comparison can lead to a call of a particular base or a no call, e.g., when two or more scores are close to each other. For example, one could use intensities that are normalized. Other base-calling methods are described in Ledergerber C and Dessimoz C, “Base-calling for next-generation sequencing platforms” Brief. Bioinform. 2011; 12:489-497.

A basecaller can provide a quality score for a base call at a particular position of a sequence read. The quality score can correspond to the base score from the base to which a preliminary base score is made. In other embodiments, the preliminary base score can be determined from the base scores of multiple bases, e.g., from the top two base scores. For instance, a difference of the top two base scores can be used as a quality score. The quality score can be used to determine whether a base call is made, and the quality score can be used in assembly. Normally, only one quality score is obtained (or no quality score if it is a no call). The description herein using bases as an example of a monomer is equally applicable for other monomer besides bases, and thus is generally applicable to various types of monomer calls.

### II. Doublets and Other Multiplets

Typically, in genome sequencing, basecalling assigns a particular base (A, C, G, T, or N, where N is a “no call”) to a position of a sequence read of the nucleic acid molecule (e.g., a DNA fragment) being sequenced. Current technologies assign only one particular base to a position in the sequence read, and thus the assignment is unique.

According to embodiments described herein, doublets provide ways to incorporate two possible basecalls into a single position. A doublet can occur when there is an ambiguity in the original signals (e.g., intensities) from which the basecalls are determined. These ambiguities could stem from the noise sources in the system (e.g., noise from signals of cells adjacent to the one being analyzed).

Alternatively, such an ambiguity could have an underlying biological process, e.g., two separate types of reactions happening on different copies of a heteropolymer fragment, e.g., different copies a target nucleic acid template, as may occur in a DNB. For instance, if the extension step in combinatorial probe anchor ligation (cPAL) is incomplete, some copies of the genomic material on a DNB will be interrogating Position “I” while the other copies may be interrogating Position “J,” or other positions. For instance, in one embodiment, J is mod 6 of I.

Using doublets, one could retain more of the information, while forcing a singleton call (one base call) results in a loss of information. For example, when there are two nearly equal signals, one cannot expect to do any better than 50/50. But, if a singleton call is required to be the maximum, information is lost.

Forcing a single basecall (singleton call) when there is an ambiguity results in a loss of information. Suppose the following two scenarios:

1. The scores are as follows: A=0.90 C=0.00 G=0.00 T=0.10.

2. The scores are as follows: A=0.51 C=0.49 G=0.00 T=0.00.

Forcing a singleton call on these two scenarios results in an A basecall in both cases. However, in the second scenario, the basecall may also be C, and this A/C ambiguity is lost in the singleton call of A. On the other hand, a doublet call retains the information in the case of Scenario 2. A doublet call can present this base of a preliminary base call as A/C, as opposed to just A.

The concept of doublets could be extended to triplets, in which three possible base assignments are done. As used herein, the term “multiplets” includes doublets and triplets. The majority of the ambiguities are expected to fall under the doublet scenario.

Doublet calls can be made for most sequencing technologies. In one embodiment, to properly enable doublets, the basecalling process can ensure that the correct singleton basecall is contained within the doublet call with a high probability, e.g., greater than 90%. When the monomer is a base, embodiments can determine four base scores as part of ensuring that the correct singleton basecall is contained within the doublet call. The base scores can correlate (or at least rank correlate) with the errors in the scores.

### III. Identifying Doublets

Doublets can be identified in various ways. As an example, assume there are four basecalls (Call1, Call2, Call3, Call4), and each basecall has a representative score (Score1, Score2, Score3, Score4). Below are a few possible scenarios, where Score1 is the highest score.

In scenario I, the following process can be performed.

1. Assign a Singleton call when Score1 is greater than Threshold1, e.g., 0.9.

2. Assign a Doublet when Score1 is in an intermediate range [Threshold2 Threshold1], e.g., [0.5 0.9].

3. Assign a No-Call when Score1 is lower than Threshold2.

In scenario II, the following process can be performed.

(1) Assign a Singleton call when Score1 is greater than or equal to Threshold1, e.g., 0.9.

(2) Assign a Doublet when Score1 is less than Threshold1.

Other scenarios are also possible. Scenario I is more informative than scenario II, as it includes a no-call. Scenario II can be more appropriate for techniques where no-calls cannot be tolerated. For example, there may be some downstream processes (e.g., mapping and/or assembly) that cannot work with no-calls.

In some embodiments, no-call doublets can co-exist as a type of soft no-calls. For example, one downstream process can assume the position is a no-call, and another downstream process can consider the position as a doublet. In one implementation, mapping can consider the position as a no-call, and an assembly process can consider the position to be a doublet.

In other scenarios, two or more scores can be used to determine a metric, which can then be compared to a threshold to determine whether to make a multiplet call. For example, a difference between Score1 and Score2 (second highest score) can be used to determine the metric, where a lower metric is more indication of a doublet, a no-call, or a no-call doublet. Similarly, Score2 can be compared to a threshold (e.g., threshold2), and if Score2 is sufficiently high, then Score2 and Score1 can be deemed sufficiently close to call a doublet or higher. The value of Score3 and/or Score4 can be used to determine whether a no-call should be made instead of a doublet, e.g., when these values are close to Score1 and Score2.

Higher order multiplets can be determined based on Score2 or lower scores, e.g., when at least a doublet has been identified. For example, Score2 can be compared to threshold values, and if Score2 is sufficiently low (e.g., in an intermediate region), then a multiplet could be called or deemed possible, depending on further analysis. For instance, if a multiplet is possible (e.g., Score2 is sufficiently low), then Score3 can be compared to one or more thresholds to determine whether a triplet should be called.

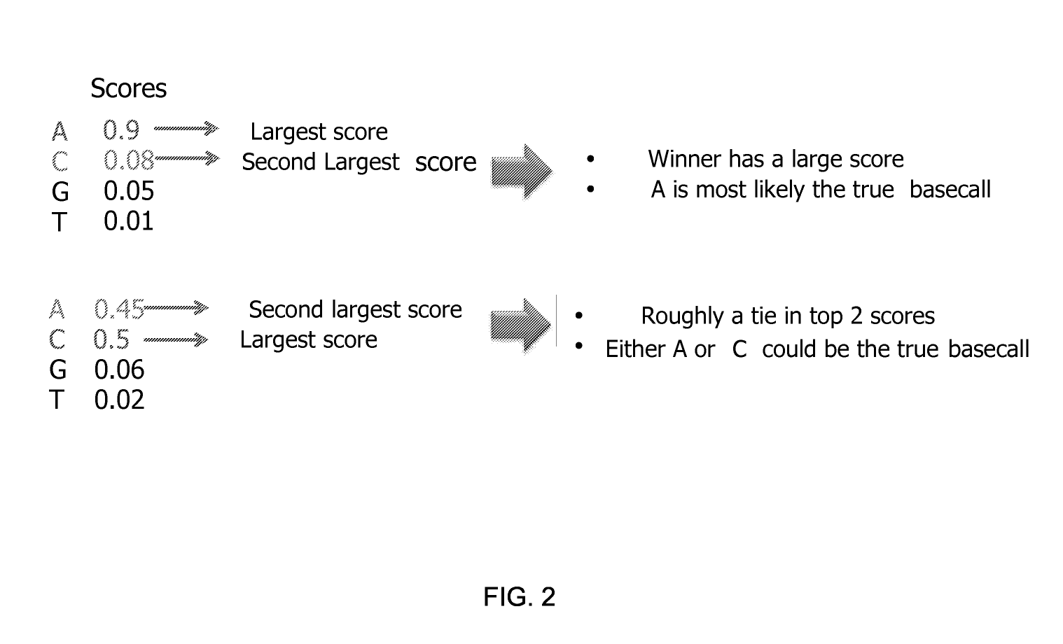

FIG. 2 shows one example where a singleton call is made and another example where a doublet is called according to embodiments of the present invention. In the first example, A has a score of 0.9, and C has the next highest score of 0.08. Given that the difference between the two scores is so large, or that the highest score is above a threshold, A can be made as a singleton call. In the second example, C has the largest score of 0.5, but the second largest score is 0.45, which is quite close. Thus, a doublet call is made, which may be recorded as A/C.

### IV. Use of Multiplets

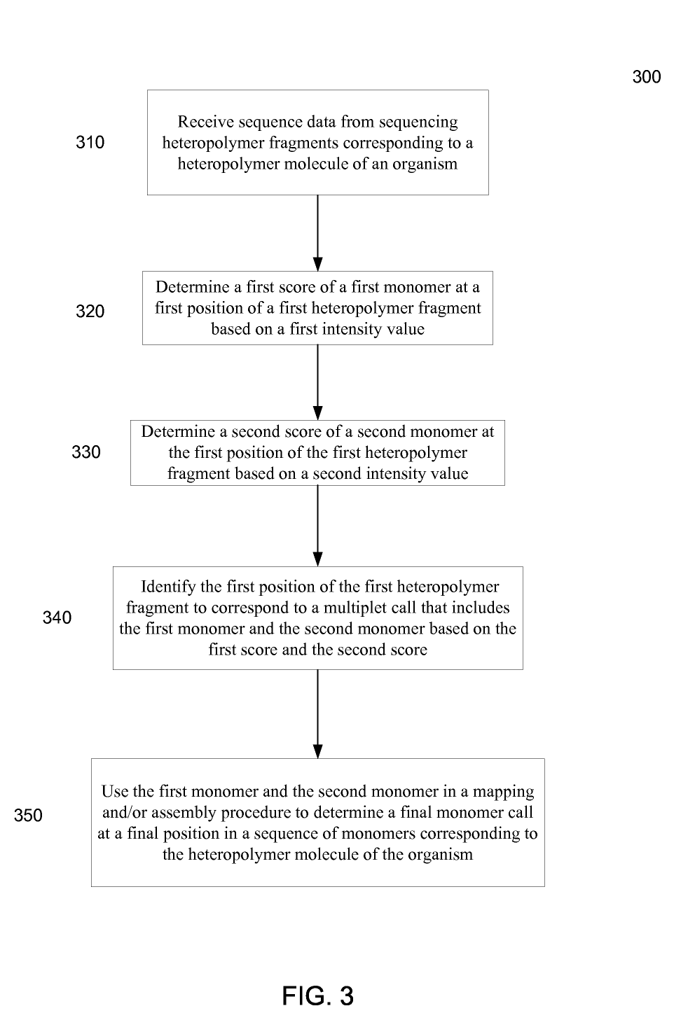

FIG. 3 is a flowchart of a method 300 for determining at a least a portion of a sequence of a heteropolymer molecule of an organism according to embodiments of the present invention. Method 300 can be performed by a computer system.

At block 310, sequence data from a sequencing of a plurality of heteropolymer fragments is received. The plurality of heteropolymer fragments correspond to a heteropolymer molecule of an organism. For example, the heteropolymer fragments can be DNA fragments corresponding to a particular chromosome of the organism (e.g., a human or other animal). As other examples, heteropolymer fragments can be RNA fragments or protein fragments. The heteropolymer fragments can be obtained from a sample of the organism, e.g., cells in a tissue sample or call-free DNA fragments in a sample, such as blood. The receiving of the sequence data can occur after or while the sequencing is occurring.

The sequence data for each of the plurality of heteropolymer fragments includes intensity values for monomers at a plurality of positions of the heteropolymer fragment. For example, the intensity values can correspond to different bases. The intensity values can result from different fluorescent probes that are used to interrogate the positions of a nucleic acid fragment. The sequence data can specify which position on which heteropolymer fragment an intensity value corresponds. Alternatively, the order of the sequence data can be specified, and thus which position on which heteropolymer fragment can be determined from the order of the sequence data. The sequencing can be performed via any sequencing technique, e.g., as referred to above.

Regardless of the sequencing technique, separate intensity values for each potential monomer can be obtained for each of a plurality of positions for each of the plurality of heteropolymer fragments. The separate intensity values at a particular positions can be used to determine scores for the monomers at the position. Intensity values at neighboring positions on an array of different heteropolymer fragments. Intensity values at neighboring positions on a heteropolymer fragment can also be used.

At block 320, a first score of a first monomer is determined at a first position of a first heteropolymer fragment based on a first intensity value of the first monomer measured at the first position. The first score provides a measure of a first likelihood of the first monomer being at the first position of the first heteropolymer fragment. For example, a first base score can be determined using a machine learning model, as described in U.S. Non-Provisional application Ser. No. 14/571,022. Other examples may use normalized intensity values, non-linear regression, or other suitable techniques, e.g., as described herein. The first score may be determined based on other intensity values of other monomers, in addition to the first intensity value of the first monomer.

The first position may be identified as a particular position from an adaptor at a particular position of the heteropolymer fragment. Many copies of the heteropolymer fragment may be interrogated to obtain the first intensity value. The first heteropolymer fragment can be identified as being at one position of the an ordered array or a cluster of a non-ordered array.

At block 330, a second score of a second monomer is determined at the first position of the first heteropolymer fragment based on a second intensity value of the second monomer measured at the first position. The second score provides a measure of a second likelihood of the second monomer being at the first position of the first heteropolymer fragment. The first and second scores can be normalized (e.g., such that a score of all of the scores is one), and thus the scores may depend on the other intensity values.

At block 340, the first position of the first heteropolymer fragment can be identified as corresponding to a multiplet call that includes the first monomer and the second monomer based on the first score and the second score. As examples, the multiplet call may be a doublet or a triplet. The multiplet may include an identification of which monomer has the highest score, and may include the scores.

The first score and the second score may be used in a variety of ways. For example, the scores may be compared to each other to determine the highest score. If there are four monomers (e.g., for bases), all four scores may be compared to each other to determine the highest score. The highest score can then be compared to one or more thresholds, e.g., as described in section III. As another example, a difference between the first score and the second score can be used as a metric that can be compared to a threshold to determine whether to make a multiplet call at the first position.

To identify the multiplet call, the first score can be determined to be a highest score of the set of monomers (e.g., 4 bases) at the first position of the first heteropolymer fragment. The first score can be compared to a first threshold (e.g., Threshold1 of section III) to determine that determine that the first score is below the first threshold. The first position can then be identified as corresponding to the multiplet call based on the first score being below the first threshold. Further, to identify the multiplet call, the first score can be determined to be above a second threshold. The first position can be identified as corresponding to a multiplet call based on the first score being above the second threshold.

The second highest score (second score) can also be used. The second score can be determined to be above a second threshold, and the first position can be identified as corresponding to a multiplet call based on the second score being above the second threshold.

At block 350, the first monomer and the second monomer are used in a mapping procedure and/or an assembly procedure to determine a final monomer call at a final position in a sequence of monomers corresponding to the heteropolymer molecule of the organism. The sequence can be all or part of the heteropolymer molecule, e.g., the sequence may be for a particular region of a chromosome. As an example, the final monomer call can correspond to the base identified to be at a particular position of a genome, or an amino acid at a particular position of a protein. The final position may be a particular position as defined by a reference sequence, which may be different than the sequence determined for the heteropolymer molecule of the organism. As another example, the final position can correspond to a particular position in an assembled sequence.

As an example, the multiplet may be used to determine multiple places in a reference sequence where the sequence read of the first heteropolymer fragment might map. The multiplet can allow for various options to be explored, given that the first position may have two options of similar likelihoods based on the first and second scores. As another example, a multiplet can be used when comparing sequence reads of other heteropolymer fragments as part of an assembly process. The different options for the sequence reads to align to an extend a contig sequence can be informed by the multiplet call. Further details are provided below.

When the multiplet call is a triplet call that includes a third monomer, a third score of the third monomer can be determined at the first position of the first heteropolymer fragment. The multiplet call can be identified based also on the third score. The third score can be used in the mapping procedure and/or the assembly procedure to determine the final monomer call at the final position in the sequence of monomers.

### V. Representation of Multiplets

Doublets can be represented on a read using different methods. The below methodology describes a way of showing doublets, which allows doublets to fit most of the standard sequence representation formats such as FastQ. Triplets and higher order multiplet can be represented in a similar manner, e.g., but with additional bases.

Since doublets are made up of two bases, one could borrow the convention used to show single nucleotide polymorphisms (SNPs). Consider the IUPAC codes for SNPs (Table 1). These codes contain all the possibilities for the doublets. However, the codes miss the order information for which base had a higher score, which may be helpful for particular uses of multiplets.

TABLE 1

| IUPAC Code | Meaning |
|---|---|
| M | A/C |
| R | A/G |
| W | A/T |
| S | C/G |
| Y | C/T |
| K | G/T |

To address this problem, embodiments can rank the doublets as XY or YX, the former meaning X call has a higher score than the Y call. Conversely, the latter means that Y call has a higher score than the X call. As another example, embodiments can define the following convention: If the order of the doublet matches the alphabetical order of the underlying bases, then use the uppercase IUPAC code. Otherwise, use a lowercase IUPAC code. For example, CT and TC can be shown as Y and y, respectively. Also AC and CA can be shown as M and m, respectively.

The resulting single-letter convention can encapsulate both bases and the order of both bases of a doublet. For FastQ files, there is one position for the score. In this case, depending on the application, either the max(Score1, Score2) or min(Score1, Score2) can be placed for the score position of the doublet base. The other score for a doublet can be associated with the position. For example, an auxiliary read can be associated with the read. The auxiliary read can store doublet scores if they exist. If there is a doublet at a position, then the position would have another score. If there is a singleton, then no other score would be stored for the auxiliary read.

### VI. Multiple Doublets on Same Read

More than one multiplet (e.g., doublet) can exist on a sequence read. The more doublets that exist, the more possible combinations there are for the sequence read of the heteropolymer fragment. Specifically, N doublets result in 2^{N} combinations for the sequence read.

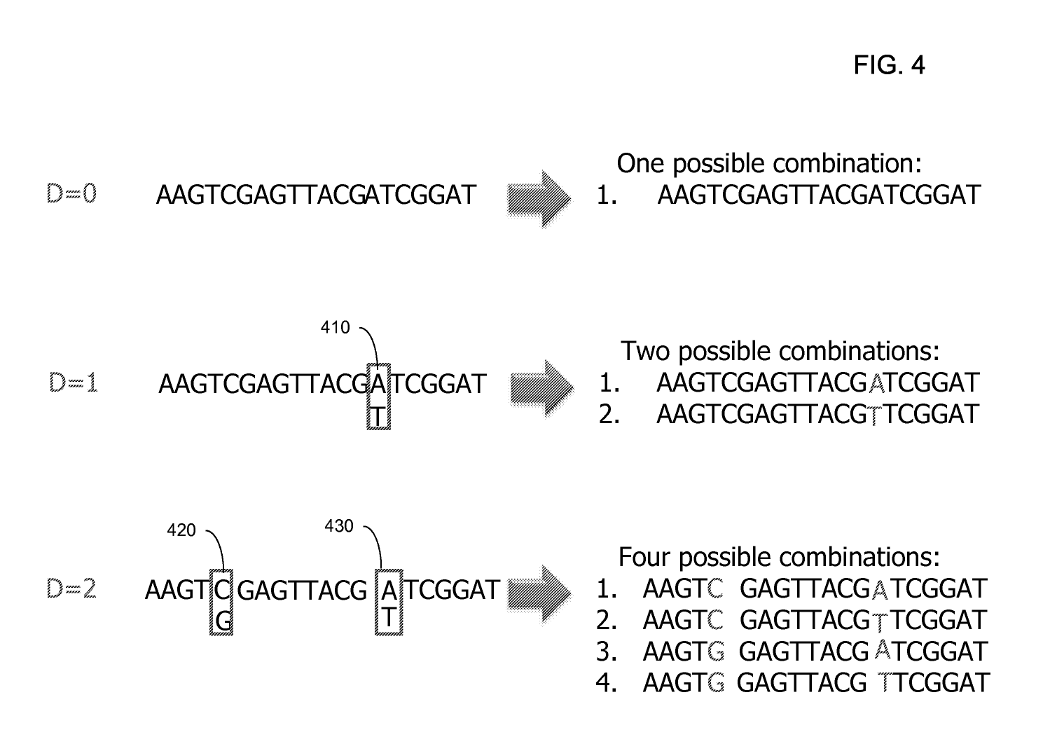

FIG. 4 shows the number of combinations resulting from different numbers of doublets according to embodiments of the present invention. For no doublets (D=0), there is one possible sequence read (or at least only one possible sequence read is identified). For one doublet (D=1), there are two possible sequence reads. Namely, one sequence read that has A at position 410, and another read that has T at position 410.

For two doublets (D=2), there are four possible sequence reads. A first possible sequence read has C at position 420 and A at position 430. A second possible sequence read has C at position 420 and T at position 430. A third possible sequence read has G at position 420 and A at position 430. A fourth possible sequence read has G at position 420 and T at position 430.

Each one of the combinations can be used in a mapping procedure and/or an assembly procedure. For example, each possible sequence read can get a mapping score for mapping the possible sequence read to a reference sequence. A mapping score for one location can correspond to whether there are any mismatches for mapping the possible sequence read to the one location. A mismatch corresponds to a number of monomers that are different for the best alignment at the one location. A sequence read can map to multiple locations with a same number of mismatches. One or two mismatches are typically used. Thus, a mapping score may decrease significantly for more than two mismatches.

In some embodiments, an initial mapping score (e.g., based purely on mismatches) for a possible sequence read can be combined with a score of the monomer of a multiplet being used for the possible sequence read. For example, the mapping score can be a combination of an initial mapping score (e.g., from a mapping routine) and the score of the monomer (e.g., multiply the two scores). The multiplying can include a scaling factor. Other examples that may or may not use multiplication include (1) geometric mean (squared root of the product/multiplication of the mapping score and the monomer score); (2) arithmetic mean: sum of the two scores divided by two; and (3) ratio of the higher score to lower score, or the opposite.

In one embodiment, all possible sequence reads corresponding to a multiplet at one location can be used to determine a total mapping score for that one location. For example, for D=2, a sum of CA and CT mapping scores can be used as the mapping score for C at position 420. The mapping scores can be used to make the final base call at the one location. For example, the highest mapping score can be used as the final base call at the one location.

### VII. Downstream Uses of Multiplets

The doublet calls can be used in mapping and/or assembly. The number of doublets can depend on the thresholds used. In some embodiments, a smaller amount of doublets can be tolerated for de novo assembly, and a larger amount of doublets can be tolerated for reference-based assembly. Thus, the threshold for de novo assembly might be less, than for reference-based assembly.

A. Reference-Based Mapping

In reference-based mapping, doublets can be handled in various ways. In one embodiment: (1) Prior to mapping, all the doublets are converted to the monomer call with the highest score, and (2) The mapper works on the resulting sequence read. Thus, the doublet may not be used at this stage, since the resulting sequence read is the same as the one determined using the highest monomer scores.

In another embodiment:

(1) Prior to mapping, all the doublets are treated as no-calls. These are doublet-converted no-calls.

(2) The mapper works with the no-calls, assuming the mapper is no-call tolerant.

(3) Once mapped to a reference sequence, the assembly can continue with either doublet-converted no-calls or with the original doublets. This latter method assumes that the assembly process can handle doublets. Alternatively, the doublet can be resolved to its highest possible basecall, and the assembly algorithm can continue using that base.

Accordingly, a sequence read corresponding to the first heteropolymer fragment is determined to have a no-call at the first position. The sequence read can be mapped to a location of the reference sequence, where the location includes the final position in the sequence of monomers. Then, the first score and the second score can be used in the assembly procedure involving the sequence read at the final position to determine the final monomer call at the final position in the sequence of monomers.

When using an original doublet in an assembly procedure after mapping, the sequence reads aligning to a particular position can be compared to each other. For example, the some of the sequence reads may have doublets and some may not. The predominant base may have the second highest score in some sequence reads, but overall there are more sequence reads with the predominant base. If a singleton call was used, the proper count for the predominant base may be inaccurate, and cause another base to be called. Using a doublet can also potentially help the identification of a variation in the final sequence.

In one implementation, the monomer score (also called a quality score) for each monomer for each sequence read at a position can be summed and then compared. Thus, the monomer scores can be used to weight the contributions from the various sequence reads that map to the position being determined. The mapping scores (e.g., as a combination of an initial mapping score and a monomer score) can be summed.

In yet another embodiment:

(1) The mapper is adjusted to be doublet-aware. It, therefore, can explicitly use the doublet information to properly find the location of the read on the reference genome. For instance, by considering all the combinations of the doublets on the read or a subset of the read. Accordingly, one or more first sequence reads include the first monomer at the first position, and one or more second sequence reads include the second monomer at the first position. Mapping the first sequence read(s) to a reference sequence can provide first mapping score(s) based on the first score, and mapping the second sequence read(s) to the reference sequence can provide mapping score(s) based on the second score. The possible sequence read with the highest mapping score can then be used. The score of the monomer can be combined with an initial mapping score (e.g., a raw matching score from a mapping routine) to determine the highest mapping score. Thus, the obtaining of mapping scores for different combinations of a sequence read can be based on the scores of for the monomers of different combinations.

(2) Once mapped, the assembly process can either work with the doublets or not. If not, the doublets can be changed to the base with the highest score or no-calls can be used, and the assembly process can continue with the highest base or a no-call. In another implementation, the possible sequence read with the highest mapping score can be the only possible sequence read used in the assembly process. As another example, the different monomers at the doublets can be used at the one location with the highest mapping score. For instance, mapping and/or monomer scores can be summed at doublet positions that exist after mapping all of the sequence reads, where the location with the highest mapping score is used as the only location for the possible sequence reads of a particular heteropolymer fragment. Accordingly, the first mapping scores and the second mapping scores can be used to determine the final monomer call at the final position in the sequence of monomers corresponding to the heteropolymer molecule of the organism. In one embodiment, the final position in the monomer sequence (e.g., genome) corresponds to where the first position in at least one of the first and second sequence reads maps to the reference sequence.

Accordingly, mapping can use scores, e.g., where matching and quality scores are summed or multiplied to get a mapping score. For example, a quality score of 0.5 for a base can be summed with a matching score (initial mapping score) of 0.4 to provide a total mapping score of 0.9. In one implementation, the sequence read with the top mapping score can be used in assembly at the mapped location. If both are close, then the doublet can be carried to assembly.

The matching score can be for the whole read (e.g., related to number of mismatches and complexity of sequence), but a mapping score can be for a particular position. If there is more than one doublet on a read, then having the mapping score be associated with a particular position can be advantageous. In this manner, both scores can contribute to an overall score for a likelihood of a base being at a final position of the heteropolymer molecule. When a mapping score is below a mapping threshold, a first sequence read can be discarded (i.e., not used).

In one embodiment, the monomer quality score and the mapping score (e.g., just the matching score) are carried forward for each possible sequence (e.g., into assembly). The scores can be carried forward for just one location (i.e., in the reference) that has the highest mapping score. The quality and matching scores for the various sequence reads mapping to a location can then be used, e.g., as described above.

In one embodiment, the mapping can be done to a set of codes, e.g., artificial sequences that are attached to DNA or other molecules. This mapping may be performed for a certain part of a sequence read that is known to correspond to at artificial sequence, which may correspond to a particular aliquot. In this manner, the correct aliquot can be identified.

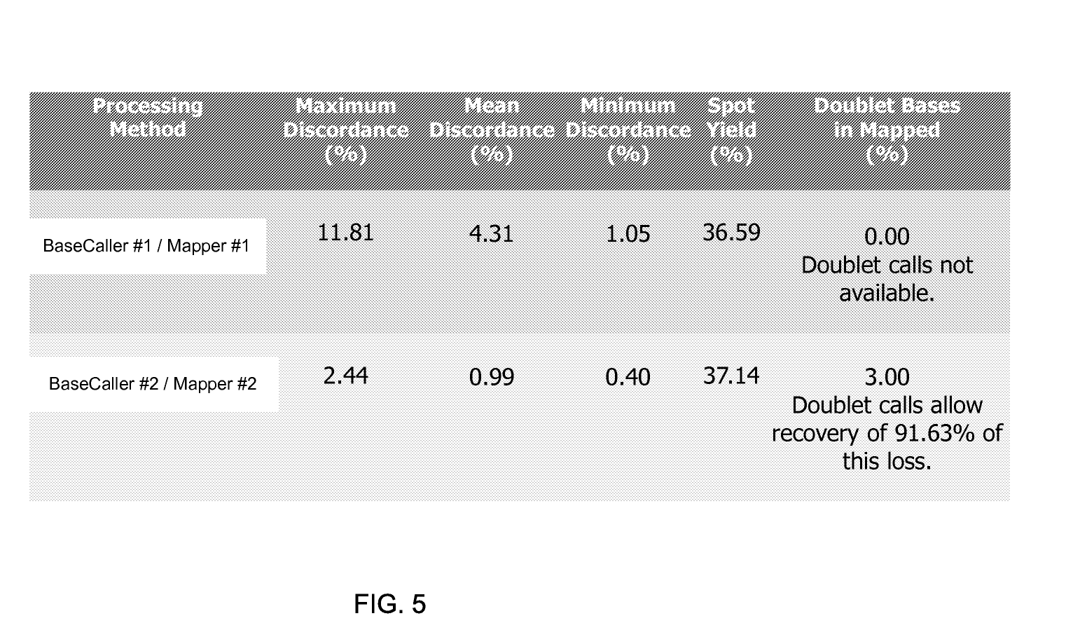

FIG. 5 is a table showing errors (discordances) between a first basecaller/mapper and a second basecaller/mapper according to embodiments of the present invention. For each basecaller/map, the sequence read is determined using the basecaller, and the mapper maps the sequence read to a reference sequence. A discordance is when a basecall at a position is different from the reference sequence. Some differences can result from actual sequence variants, but the amount of actual variants is about 0.1%. The sequence reads are all the same length, and thus each position of a read can be analyzed for all of the reads.

The first basecaller (basecaller #1) does not use doublets and uses a regression model to determine a base call. The first mapper (mapper #1) cannot handle many no-calls (e.g., only 1 or 2 no-calls for one read). The second basecaller (basecaller #2) uses doublets and is a machine learning model. The second mapper (mapper #2) can handle more than two no-calls. The second mapper can simultaneously map both arms of a mate pair, which can allow identifying the correct location when one arm maps to many locations (e.g., the first mapper might save the correct location by only saving a maximum amount of locations for a first arm that maps to many location). There may or may not be internal gaps between the two arm reads.

Spot yield corresponds to the number of DNA molecules detected divided by the number of spots available (e.g., number of spots in an array). The second mapper can have more accurate mapping and higher yield as it considers both arms simultaneously. For the second basecaller, 3% of the basecalls are doublets. The 91.63% refers to the number of doublets that include the correct base and are thus recoverable as a correct base call.

The maximum discordance corresponds to the position having the most errors in the set of reads. In FIG. 5, the first basecaller/mapper has a position of maximum discordance that differs from the reference in 11.81% of the reads. The second basecaller/mapper has a position of maximum discordance that differs from the reference in only 2.44% of the reads.

The minimum discordance corresponds to the position having the least errors in the set of reads. In FIG. 5, the second basecaller/mapper has a position of minimum discordance that differs from the reference in 1.05% of the reads. The second basecaller/mapper has a position of minimum discordance that differs from the reference in only 0.4% of the reads.

The mean discordance corresponds to the average percentage of reads that have an error across all positions. In FIG. 4, the first basecaller/mapper has a mean discordance of 4.31%. The second basecaller/mapper has a mean discordance of only 0.99% of the reads. Accordingly, the second basecaller/mapper is more accurate than the first basecaller/mapper when doublets are used by the second basecaller/mapper.

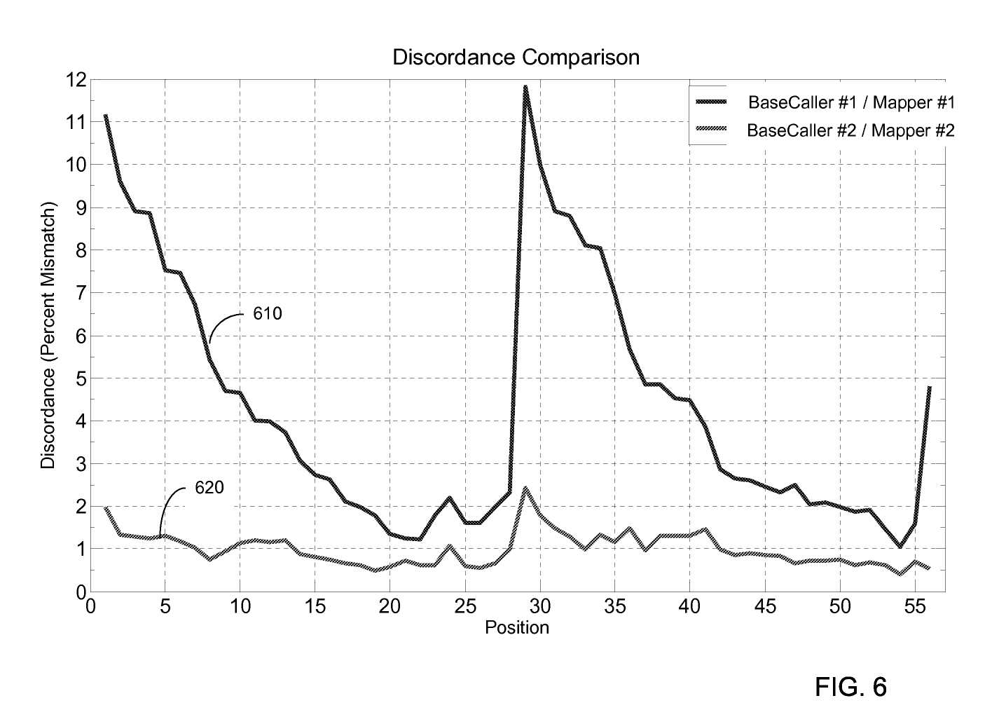

FIG. 6 shows a plot of the percent of discordances at positions in a set of reads having 56 bases according to embodiments of the present invention. The horizontal axis is the position number in the sequence reads. The number of positions is 56. The vertical axis shows the percent of reads that have a mismatch from the reference sequence. As one can see, the first position of each arm is most likely to have an error.

Curve 610 shows the errors for the first basecaller/mapper. Curve 620 shows the errors for the second basecaller/mapper. As one can see, the percent of discordances are lower when doublets are used, as for the second basecall/mapper.

B. De Novo Mapping

A Kmer index can be used in de novo assembly, e.g., as described in U.S. Patent Publication 2015/005794. A Kmer index can be created from portions of the sequence reads that have a length of K monomers. The Kmers are sequences of length K that can be efficiently assembled.

In one embodiment, when doublets are present in the sequences, the Kmers are no longer made of individual bases. For example, a particular Kmer can include two bases at a particular position as a part of a doublet. In another embodiment, multiple Kmers are created as a result of the doublet. For example, one doublet would result in two Kmers for a particular subset of the read that includes the position.

To handle these cases, a few scenarios are possible, including the following:

(1) All the doublets are changed to the base with the highest score, and then the de novo process continues as usual.

(2) All the doublets are changed to no-calls, and then effectively, all the Kmers that include those doublets are ignored, which can cause a reduction on the yield of the Kmers. The process, then, continues using the reduced set kmers.

(3) All the possibilities of the doublets are checked on a Kmer. For instance, if a Kmer has two doublets, there are 2×2=4 possibilities for that Kmer, only one of which is correct. Nevertheless, all the four combinations can enter the Kmer index for processing. The price for this expansion is the expansion in the size of the Kmer index. For all the practical purposes, one could only consider kmers with 0, 1 or 2 doublets. Typically (e.g., if the basecalling process functions properly), the sum of the memberships in these three classes should make up the majority of the Kmers; and therefore the Kmer loss should be minimized (e.g., <5%).

Accordingly, in one embodiment, the combination of all possible reads is put in the Kmer index. The RKI (Read Kmer Index) can be a terabyte in size. Further details about de novo assembly can be found in U.S. Patent Publication 2015/005794, which is incorporated by reference. For example, multiple Kmers can be generated from a sequence reads by selecting different Kmers using a sliding window of K bases. A same Kmer can be identified in various reads, with the Kmer being represented by one entry that is associated with each of the reads from which the Kmer was identified.

Thus, a first possible sequence read of a heteropolymer fragment can include the first monomer at the first position, and a first plurality of Kmers can be extracted with the first monomer at the first position. And, a second possible sequence read of the heteropolymer fragment can include the second monomer at the first position, and a second plurality of Kmers can be extracted with the second monomer at the first position. Creating the Kmer index can generally include using the first and second plurality of Kmers.

The number of doublets allowed in a Kmer can be restricted. For example, three doublets may not be allowed. Such a restriction can affect the yield, as not all Kmers would be usable. But, such Kmers are more likely to include an error, and thus the removal of such Kmers can be beneficial.

As multiple Kmers can be created for a same interval on a sequence read (e.g., two Kmers for a doublet call), the number of Kmers will increase relative to not using multiplets. Thus, the size of the RKI will grow. The percentage of increase can depend on the size of Kmers and the number of multiplets. As an estimate, 5% doublet calls would result in RKI doubling. The percentage of doublets may be less than 5%. For 1% doublets, the RKI would grow by about 10%-20%.

The RKI is then used to assemble a contig, e.g., as described in U.S. Patent Publication 2015/005794. For example, at one end of a contig, Kmers that match to the end of the contig can be identified. Multiple Kmers can match, with different Kmers corresponding to different branches of how the contig can be extended. In one embodiment, the branch for extension is the one that has the most support (e.g., a Kmer that is associated with the most reads). The extension can also use read scores associated with the reads.

A measure of support can also include the score of a particular base of a doublet. Using the scores of the monomers of the set of sequence reads can include computing a sum of the scores for each monomer; and using the monomer having a highest sum as the final monomer call. For example, an entry for a Kmer can include a read score for a particular read in association with the Kmer, where the read score is determined from the score for the base that was included in the Kmer. The read score can be less when the Kmer includes the base with the second highest score as opposed to the highest score. Accordingly, the base scores can be used to eliminate incorrect base calls. For the storage of Kmers, a first Kmer of the first plurality of Kmers can be stored in the Kmer index in association with a first read score corresponding to a heteropolymer fragment, and a second Kmer of the second plurality of Kmers can be stored in the Kmer index in association with a second read score corresponding to the heteropolymer fragment.

In one embodiment, extending the contig can use a set of Kmers that align to an end of the contig. For each Kmer of the set of Kmers, a Kmer score can be computed based on the read scores associated with the Kmer. The Kmer scores can be used to determine which Kmer to use to extend the contig.

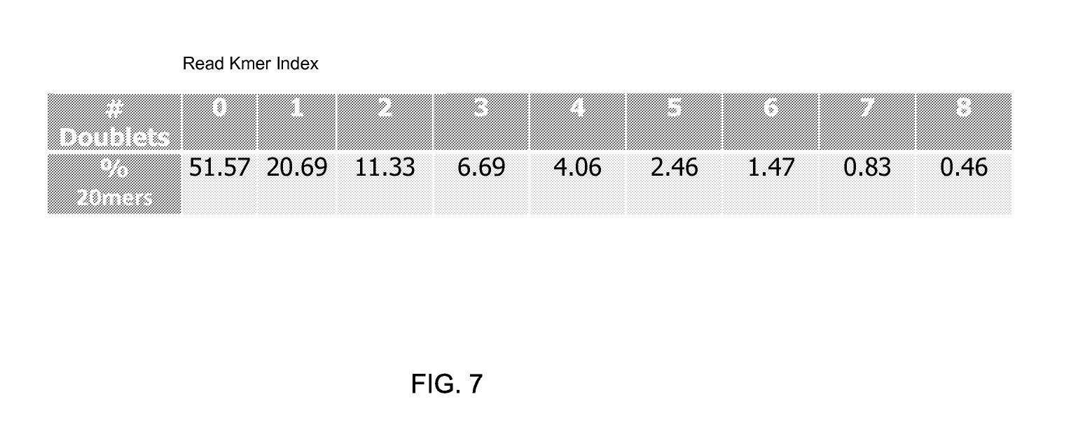

FIG. 7 is a table showing the percentage of Kmers that have various numbers of doublets according to embodiments of the present invention. The Kmers are 20 mers. A little more than 50% of the 20 mers do not have any doublets. About 20% of the Kmers have one doublet. The percentage of Kmers decreases with the number of doublets. The percentages can change for Kmers of a different size.

Overall, the monomer scores can be used in mapping or assembly in a variety of ways. For example, the scores can be used to determine a metric, which can then be used in mapping or assembly. For example, the metric can be used to determine a mapping score or a reliability of a Kmer in de novo assembly or reliability of a base at a read for reference-based assembly. The metric can then be used to determine which monomer to use as a final monomer call at a final position. Using a monomer score in the later mapping and/or assembly processes allows data from mapping or similarities in Kmers to help determine which base is correct. Since other data is used at a later stage and a call is not forced at a an earlier stage, more accuracy can be obtained.

### VIII. Results

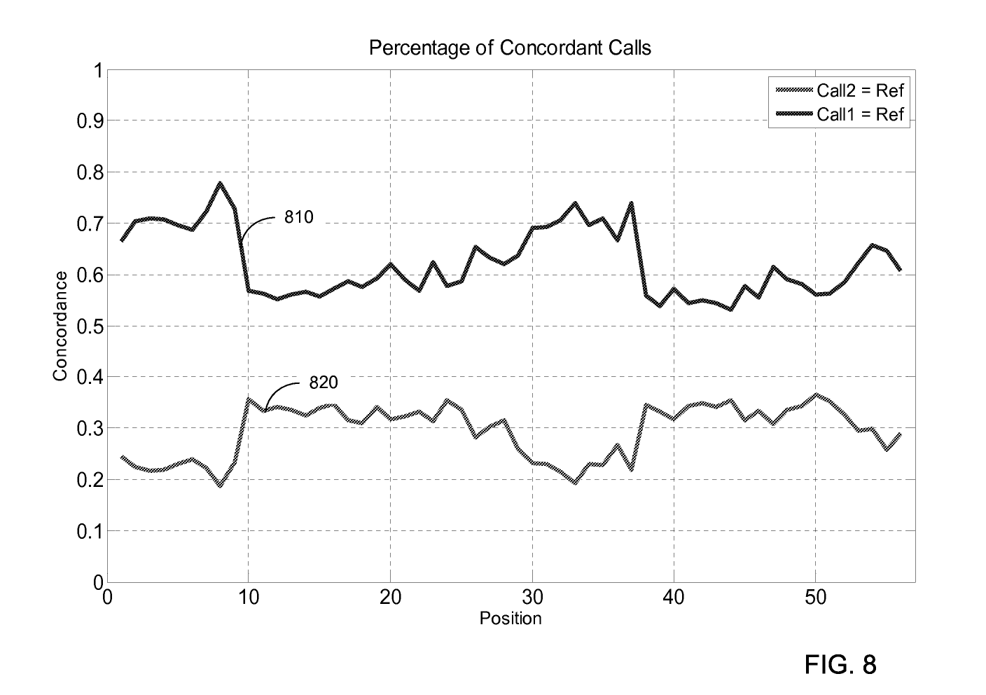

FIG. 8 is a plot showing a percentage of concordant base calls for the base call with the highest score and the second highest score according to embodiments of the present invention. The vertical axis corresponds to the fractional concordance of the base call relative to the reference. The horizontal axis corresponds to the position in the sequence read.

Call1 corresponds to the base call with the highest score, and Call2 corresponds to the base call with the second highest score. Curve 810 shows the fractional concordance of the base call being Call1. Curve 820 shows the fractional concordance of the base call being Call2. As one can see, the base call with the highest score is the correct base about 55% to 75% of the time.

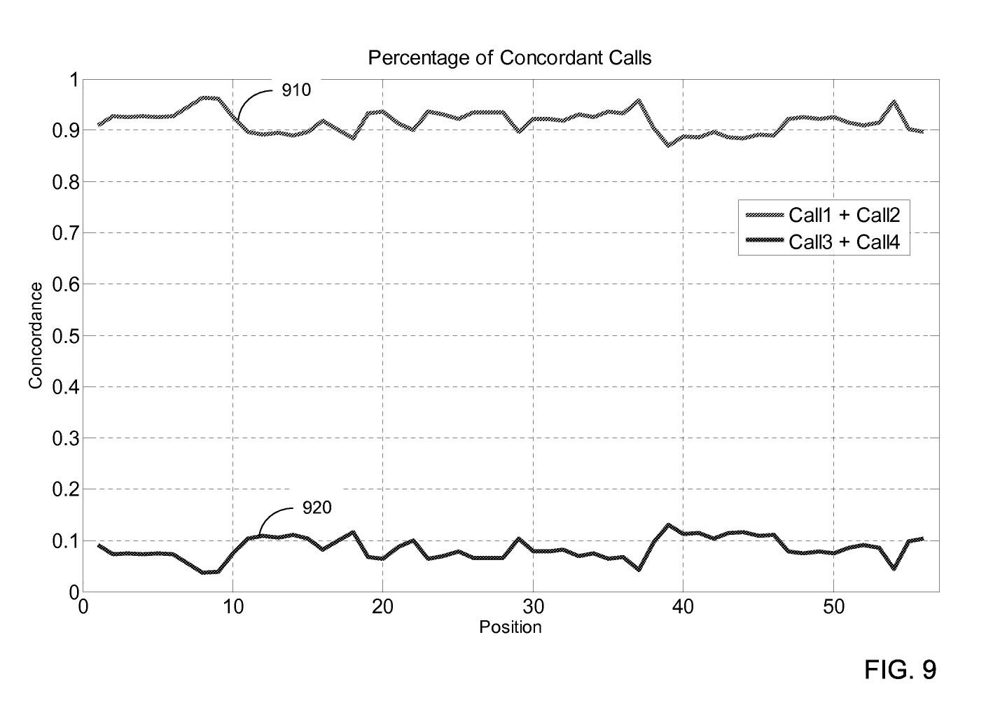

FIG. 9 is a plot showing a percentage of concordant base calls when doublets are included according to embodiments of the present invention. The vertical axis corresponds to the fractional concordance of the base call in the pair of base calls relative to the reference. The horizontal axis corresponds to the position in the sequence read.

Call1 corresponds to the base call with the highest score, Call2 corresponds to the base call with the second highest score, Call3 corresponds to the base call with the third highest score, Call4 corresponds to the base call with the lowest score. Curve 910 shows the fractional concordance of the base call being Call1 or Call2. Curve 820 shows the fractional concordance of the base call being Call3 or Call4. When a doublet includes the two scores, the correct base is included about 90% of the time. This shows the increase in accuracy obtainable by including doublets.

### IX. Computer System

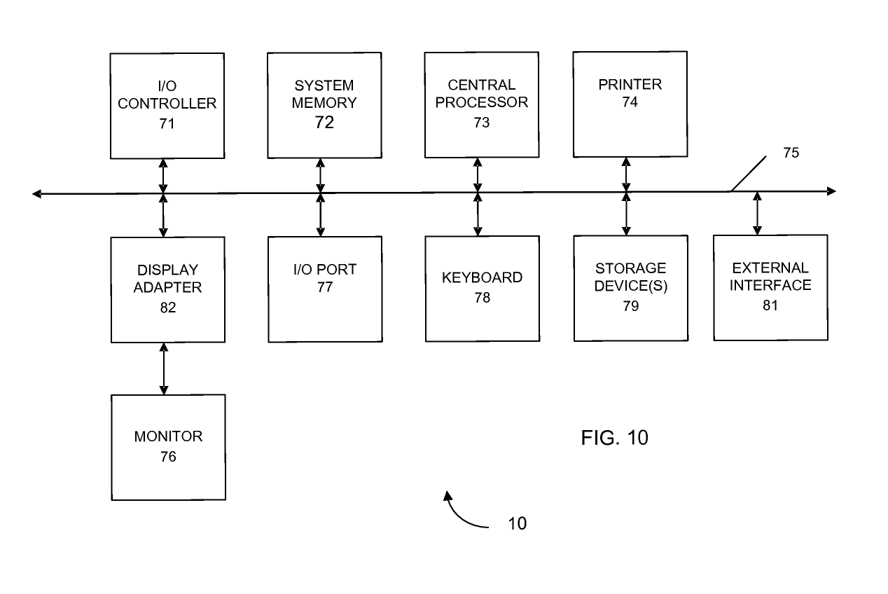

Any of the computer systems mentioned herein may utilize any suitable number of subsystems. Examples of such subsystems are shown in FIG. 10 in computer system 10. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 10 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

A computer system can include a plurality of the same components or subsystems, e.g., connected together by external interface 81 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned here are incorporated by reference in their entirety for all purposes. None is admitted to be prior art.

What is claimed is:

1. A method comprising performing, by a computer system:
receiving sequence data from a sequencing of a plurality of heteropolymer fragments corresponding to a heteropolymer molecule of an organism, wherein the sequence data for each heteropolymer fragment of the plurality of heteropolymer fragments includes:
intensity values for a set of monomers at a plurality of positions of the heteropolymer fragment;
determining a first score of a first monomer at a first position of a first heteropolymer fragment based on a first intensity value of the first monomer measured at the first position, the first score providing a first likelihood of the first monomer being at the first position of the first heteropolymer fragment;
determining a second score of a second monomer at the first position of the first heteropolymer fragment based on a second intensity value of the second monomer measured at the first position, the second score providing a second likelihood of the second monomer being at the first position of the first heteropolymer fragment;
based on the first score and the second score, identifying the first position of the first heteropolymer fragment to correspond to a multiplet call that includes the first monomer and the second monomer; and
using the first monomer and the second monomer in a mapping procedure and/or an assembly procedure to determine a final monomer call at a final position in a sequence of monomers corresponding to the heteropolymer molecule of the organism.

2. The method of claim 1, further comprising, by the computer system:
using the first score and the second score in the mapping procedure and/or the assembly procedure to determine the final monomer call at the final position in the sequence of monomers.

3. The method of claim 1, wherein identifying the first position of the first heteropolymer fragment to correspond to the multiplet call includes:
determining that the first score is a highest score of the set of monomers at the first position of the first heteropolymer fragment;
comparing the first score to a first threshold;
determining that the first score is below the first threshold; and
identifying the first position as corresponding to the multiplet call based on the first score being below the first threshold.

4. The method of claim 3, further comprising, by the computer system:
determining that the first score is above a second threshold; and
identifying the first position as corresponding to the multiplet call based on the first score being above the second threshold.

5. The method of claim 4, further comprising, by the computer system:
identifying a second position as a no-call when a highest score of the set of monomers at the second position is below the second threshold.

6. The method of claim 3, further comprising, by the computer system:
determining that the second score is a second highest score of the set of monomers at the first position of the first heteropolymer fragment;
determining that the second score is above a second threshold; and
identifying the first position as corresponding to the multiplet call based on the second score being above the second threshold.

7. The method of claim 1, further comprising, by the computer system:
determining a sequence read corresponding to the first heteropolymer fragment, the sequence read having a no-call at the first position; and
mapping the sequence read to a location of a reference sequence, the location including the final position in the sequence of monomers, wherein the first score and the second score are used in the assembly procedure involving the sequence read at the final position, thereby determining the final monomer call at the final position in the sequence of monomers.

8. The method of claim 1, further comprising, by the computer system:
determining one or more first sequence reads corresponding to the first heteropolymer fragment, the one or more first sequence reads including the first monomer at the first position;
determining one or more second sequence reads corresponding to the first heteropolymer fragment, the one or more second sequence reads including the second monomer at the first position;
mapping the one or more first sequence reads to a reference sequence to obtain one or more first mapping scores based on the first score;
mapping the one or more second sequence reads to the reference sequence to obtain one or more second mapping scores based on the second score; and
using the one or more first mapping scores and the one or more second mapping scores to determine the final monomer call at the final position in the sequence of monomers corresponding to the heteropolymer molecule of the organism.

9. The method of claim 8, wherein the final position in the sequence of monomers corresponds to where the first position in at least one of the first and second sequence reads maps to the reference sequence.

10. The method of claim 8, wherein obtaining a first mapping score for a first sequence read based on the first score includes:
determining an initial mapping score that corresponds to an accuracy of mapping the first sequence read to the reference sequence; and
using the initial mapping score and the first score to determine the first mapping score.

11. The method of claim 10, wherein determining the first score includes:
multiplying the first score and the initial mapping score.

12. The method of claim 1, further comprising, by the computer system:
using the first score and the second score in the assembly procedure to determine the final monomer call at the final position in the sequence of monomers.

13. The method of claim 12, further comprising, by the computer system:
identifying a set of sequence reads that align to the final position in the sequence of monomers and that have a score for a monomer at the final position, the set of sequence reads including:
sequence reads that respectively include the first monomer and the second monomer at the first position and that correspond to the first heteropolymer fragment; and
using the scores of the monomers of the set of sequence reads to determine the final monomer call at the final position.

14. The method of claim 13, wherein using the scores of the monomers of the set of sequence reads includes:
computing a sum of the scores for each monomer of the monomers of the set of sequence reads; and
using the monomer having a highest sum as the final monomer call.

15. The method of claim 12, further comprising, by the computer system:
determining a first sequence read corresponding to the first heteropolymer fragment, the first sequence read including the first monomer at the first position;
extracting a first plurality of Kmers from the first sequence read, the first plurality of Kmers including the first monomer at the first position;
determining a second sequence read corresponding to the first heteropolymer fragment, the second sequence read including the second monomer at the first position;
extracting a second plurality of Kmers from the second sequence read, the first plurality of Kmers including the second monomer at the first position; and
creating a Kmer index including the first plurality of Kmers and the second plurality of Kmers.

16. The method of claim 15, wherein a first Kmer of the first plurality of Kmers is stored in the Kmer index in association with a first read score corresponding to the first heteropolymer fragment, the first read score being determined based on the first score, and
wherein a second Kmer of the second plurality of Kmers is stored in the Kmer index in association with a second read score corresponding to the first heteropolymer fragment, the second read score being determined based on the second score.

17. The method of claim 16, wherein the first read score is the first score.

18. The method of claim 16, further comprising:
extending a contig using Kmers in the Kmer index based on read scores associated with the Kmers in the Kmer index.

19. The method of claim 18, extending the contig includes:
identifying a set of Kmers that align to an end of the contig;
for each Kmer of the set of Kmers:
computing a Kmer score based on the read scores associated with the Kmer; and
using the Kmer scores to determine which Kmer of the set of Kmers to use to extend the contig.

20. A computer product comprising a computer readable medium storing a plurality of instructions, that when executed on one or more processors of a computer system, perform:
receiving sequence data from a sequencing of a plurality of heteropolymer fragments corresponding to a heteropolymer molecule of an organism, wherein the sequence data for each heteropolymer fragment of the plurality of heteropolymer fragments includes:
intensity values for monomers at a plurality of positions of the heteropolymer fragment;
determining a first score of a first monomer at a first position of a first heteropolymer fragment based on a first intensity value of the first monomer measured at the first position, the first score providing a first likelihood of the first monomer being at the first position of the first heteropolymer fragment;
determining a second score of a second monomer at the first position of the first heteropolymer fragment based on a second intensity value of the second monomer measured at the first position, the second score providing a second likelihood of the second monomer being at the first position of the first heteropolymer fragment;
based on the first score and the second score, identifying the first position of the first heteropolymer fragment to correspond to a multiplet call that includes the first monomer and the second monomer; and
using the first monomer and the second monomer in a mapping procedure and/or an assembly procedure to determine a final monomer call at a final position in a sequence of monomers corresponding to the heteropolymer molecule of the organism.


SEQUENCE LISTING (1 sequence)

SEQ ID NO: 1 - DNA, 20 bp, Artificial Sequence
  synthetic nucleotide sequence
aagtsgagttacgwtcggat